(19) United States
(12) Patent Application Publication
(10) Pub. No.: US 2019/0145084 A1
(43) Pub. Date: May 16, 2019

(54) PLASTIC WATER PASSAGE MAIN BODY OF THERMOSTATIC TAP

(71) Applicant: Harda (Xiamen) Plastic Co., Ltd., Xiamen (CN)

(72) Inventors: Zihua Li, Xiamen (CN); Mei Lin, Xiamen (CN)

(21) Appl. No.: 15/808,907

(22) Filed: Nov. 10, 2017

(51) Int. Cl. E03C 1/04; F16K 47/08; F16K 11/20; F16K 27/04

(52) U.S. Cl. CPC E03C 1/0403; F16K 47/08; E03C 2001/026; F16K 27/04; F16K 11/20

(57) ABSTRACT

A plastic water passage main body of a thermostatic tap includes a plastic H-shaped main body. The H-shaped main body includes a transverse pipe and two valve seats. A flow passage is provided inside the transverse pipe and the two valve seats for the transverse pipe to communicate with the two valve seats. One side wall or two side walls of the transverse pipe are provided with two openings communicating with the flow passage inside the transverse pipe. The two openings are located at the left half and the right half of the transverse pipe, respectively. Each opening is fitted with a sealing plate for sealing the opening. The plastic water passage main body of the thermostatic tap has better structural integrity and resistance to water pressure.

### BACKGROUND OF THE INVENTION

### 1. Field of the Invention

The present invention relates to a bathroom accessory, and more particularly to a plastic water passage main body of a thermostatic tap.

### 2. Description of the Prior Art

A dual-inlet thermostatic tap comprises an H-shaped water passage main body. The water passage main body is made of copper by casting to form a semi-finished product, and then the semi-finished product is processed with complicated machining. The price of copper is high and the machining is difficult. For this reason, people are trying to use plastics instead of copper for developing a plastic water passage main body of a thermostatic tap by means of injection molding technique which is suitable for mass production. Because the structure of the H-shaped plastic water passage main body is special and complicated, it is unable to produce an integral plastic water passage main body. The plastic water passage main body must be manufactured step by step.

A conventional plastic water passage main body of a thermostatic tap comprises an H-shaped frame and a sealing plate. A water outlet extending upward is disposed in the middle section of a transverse pipe of the frame. Left and right ends of the transverse pipe are respectively connected to two tubular valve seats protruding upward. A flow passage is provided in the valve seats and the transverse pipe for the valve seats to communicate with the transverse pipe. The outer wall of the upper opening portion of each valve seat is formed with outer threads. The bottom of each valve seat is provided with a water inlet pipe extending downward. The front side of the transverse pipe is formed with a passage communicating with its internal flow passage and the two valve seats. The sealing plate is fitted to the end of the passage to seal the passage. The passage penetrates through the front side of the transverse pipe. Therefore, through this passage, the mold of the plastic water passage main body of the thermostatic tap can be pulled easily to form the flow passage inside the transverse pipe, so that the plastic water passage main body has good structural integrity without using copper.

However, this plastic water passage main body has some shortcomings. The front side of the transverse pipe is provided with the passage penetrating through the front side of the transverse pipe. The sealing plate is used to seal the passage. The sealing plate is relatively long. When the thermostatic tap is used in the high pressure water flow environment, the two inlet pipes will produce a certain pressure on the transverse pipe. When the water flow of the two inlet pipes converges in the middle of the transverse pipe, the confluent water flow has the maximum impact force to the surroundings. The middle part of the long sealing plate is more flexible than the two ends. When the sealing plate is impacted by the confluent flow force, the middle of the sealing plate is easily deformed outward. The sealing plate cannot completely seal the passage, resulting in leakage and affecting the use. The conventional plastic water passage main body of the thermostatic tap has the problem of a poor resistance to water pressure. Accordingly, the present invention intends to provide a dual faucet structure for improving the shortcomings mentioned above.

### SUMMARY OF THE INVENTION

The primary object of the present invention is to provide a plastic water passage main body of a thermostatic tap, having better structural integrity and resistance to water pressure.

In order to achieve the aforesaid object, the plastic water passage main body of the thermostatic tap of the present invention comprises a plastic H-shaped main body. The H-shaped main body comprises a middle transverse pipe and two valve seats connected to left and right ends of the transverse pipe. A middle of the transverse pipe is formed with a water outlet extending upward. A flow passage is provided inside the transverse pipe and the two valve seats for the transverse pipe to communicate with the two valve seats. A bottom of each valve seat is provided with an inlet pipe extending downward. A side wall of the transverse pipe is provided with two openings communicating with the flow passage inside the transverse pipe. The two openings are located at the left half and the right half of the transverse pipe, respectively. The opening located at the left half of the transverse pipe is offset leftward from the central axis of the transverse pipe, and the opening located at the right half of the transverse pipe is offset rightward from the central axis of the transverse pipe. Each opening is fitted with a sealing plate for sealing the opening.

Preferably, the two openings are located at the two sides of the transverse pipe, respectively.

Preferably, a baffle is provided between the two openings at an intermediate portion of the transverse pipe, and the baffle is provided with a reinforcing plate inside the transverse pipe.

Preferably, the two openings are located at same side of the transverse pipe.

Preferably, one side edge of each opening, close to a central axis of the transverse pipe, is provided with a reinforcing plate inside the transverse pipe. Preferably, a periphery of each opening is formed with an inwardly recessed annular groove, and the sealing plate is formed with a boss to mate with the annular groove.

Preferably, a sealing ring is provided between the sealing plate and each opening.

Preferably, the sealing plate is connected to each opening by a welding connection or mechanical connection.

Preferably, the plastic water passage main body of the thermostatic tap further comprises a plastic housing. The housing is configured to cover the H-shaped main body and the sealing plate. The housing has a perforation for the water outlet to extend out therefrom.

According to the above structure, the present invention has the following advantages:
1. When the H-shaped main body is formed by injection molding, the flow passage inside the H-shaped main body can be formed by core-pulling through the openings and the water outlet, and then the plastic sealing plate is engaged with the opening to close the opening, achieving better structural integrity of the plastic water passage main body.
2. The two openings are located at the left half and the right half of the transverse pipe, respectively. The opening located at the left half of the transverse pipe is offset leftward from the central axis of the transverse pipe, and the opening located at the right half of the transverse pipe is offset rightward from the central axis of the transverse pipe. The sealing plate of the present invention is smaller in length than the sealing plate of the conventional plastic water passage main body so that the entire sealing plate of the present invention is less likely to be deformed. The two openings are offset from the intermediate position of the transverse pipe, which can avoid the maximum impulsive force when the sealing plate is subjected to water flow. Thus, the present invention can withstand greater water pressure, providing a good resistance to water pressure.

### BRIEF DESCRIPTION OF THE DRAWINGS

FIG. 1 is an exploded view of according to a first embodiment of the present invention;

FIG. 2 is a first sectional view of according to the first embodiment of the present invention;

FIG. 3 is a second sectional view of according to the first embodiment of the present invention;

FIG. 4 is an exploded view of according to a second embodiment of the present invention;

FIG. 5 is a first sectional view of according to the second embodiment of the present invention;

FIG. 6 is a second sectional view of according to the second embodiment of the present invention;

FIG. 7 is an exploded view of according to a third embodiment of the present invention;

FIG. 8 is an exploded view of according to a fourth embodiment of the present invention;

FIG. 9 is a perspective view of according to the fourth embodiment of the present invention;

FIG. 10 is an exploded view of according to a fifth embodiment of the present invention;

FIG. 11 is a perspective view of according to the fifth embodiment of the present invention;

FIG. 12 is a sectional view of according to the fifth embodiment of the present invention;

FIG. 13 is an exploded view of according to a sixth embodiment of the present invention;

FIG. 14 is a perspective view of according to the sixth embodiment of the present invention;

FIG. 15 is a sectional view of according to the sixth embodiment of the present invention;

FIG. 16 is an exploded view of according to a seventh embodiment of the present invention;

FIG. 17 is an exploded view of according to an eighth embodiment of the present invention; and

FIG. 18 is a perspective view of according to the eighth embodiment of the present invention.

### DETAILED DESCRIPTION OF THE PREFERRED EMBODIMENTS

Embodiments of the present invention will now be described, by way of example only, with reference to the accompanying drawings.

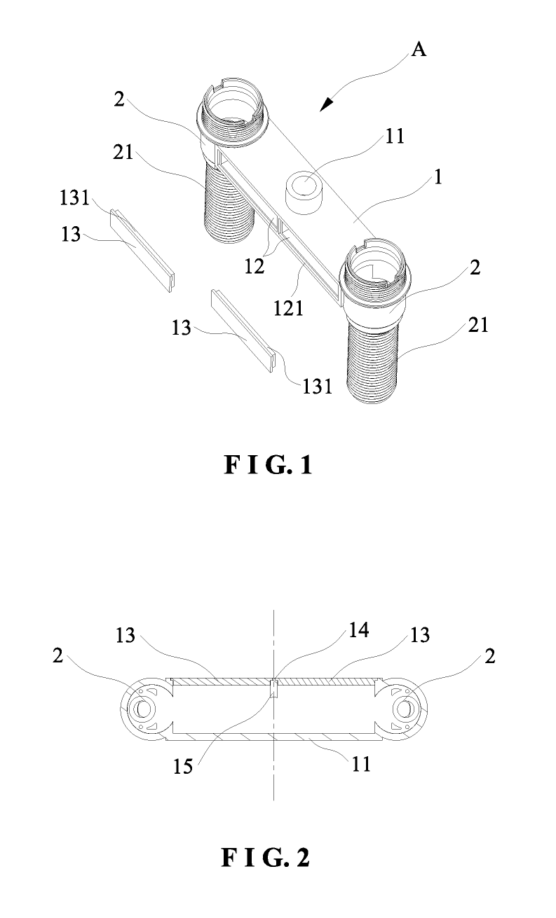

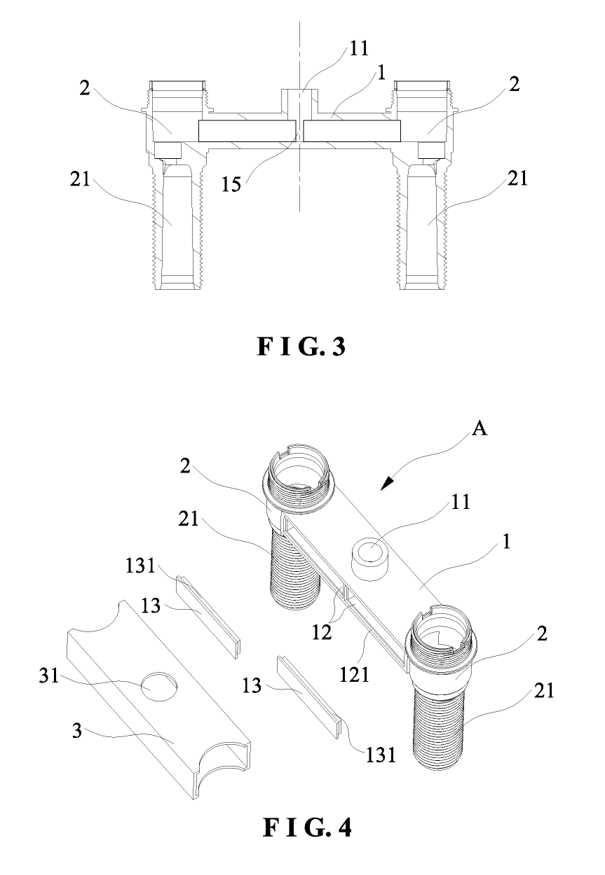

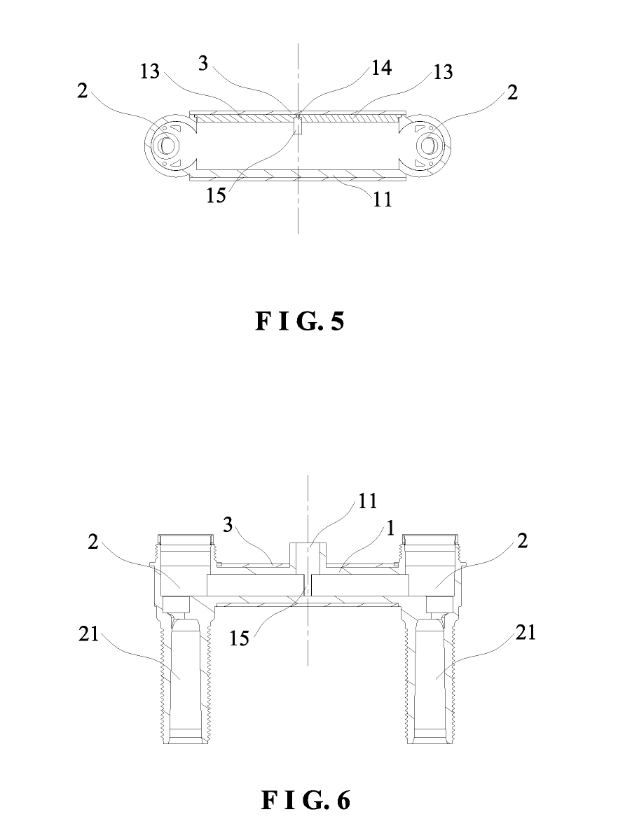

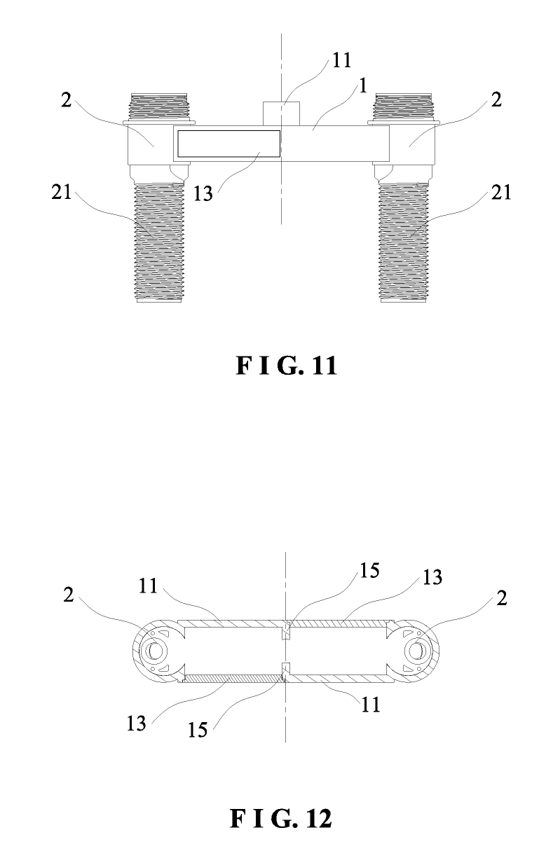

As shown in FIG. 1 to FIG. 14, the present invention discloses a plastic water passage main body of a thermostatic tap. The plastic water passage main body comprises a plastic H-shaped main body. The H-shaped main body A comprises a middle transverse pipe 1 and two valve seats 2 connected to left and right ends of the transverse pipe 1. The middle of the transverse pipe 1 is formed with a water outlet 11 extending upward. A flow passage is provided inside the transverse pipe 1 and the two valve seats 2 for the transverse pipe 1 and the two valve seats 2 to communicate with each other. The bottom of each valve seat 2 is provided with an inlet pipe 21 extending downward. The side wall of the transverse pipe 1 is provided with two openings 12 communicating with the flow passage inside the transverse pipe 1. The two openings 12 are located at the left half and the right half of the transverse pipe 1, respectively. The opening 12 located at the left half of the transverse pipe 1 is offset leftward from the central axis of the transverse pipe 1, and the opening 12 located at the right half of the transverse pipe 1 is offset rightward from the central axis of the transverse pipe 1. Each opening 12 is fitted with a sealing plate 13 for sealing the opening 12.

In the present invention, when the H-shaped main body A is formed by injection molding, the flow passage inside the H-shaped main body A may be formed by core-pulling through the opening 12 and the water outlet 11, and then the plastic sealing plate 13 is engaged with the opening 12 to close the opening 12, achieving better structural integrity of the plastic water passage main body. The two openings 12 are located at the left half and the right half of the transverse pipe 1, respectively. The opening 12 located at the left half of the transverse pipe 1 is offset leftward from the central axis of the transverse pipe 1, and the opening 12 located at the right half of the transverse pipe 1 is offset rightward from the central axis of the transverse pipe 1. The sealing plate 13 of the present invention is smaller in length than the sealing plate 13 of the conventional plastic water passage main body so that the entire sealing plate 13 of the present invention is less likely to be deformed. The two openings 12 are offset from the intermediate position of the transverse pipe 1, which can avoid the maximum impulsive force when the sealing plate 13 is subjected to water flow. Thus, the present invention can withstand greater water pressure, providing a good resistance to water pressure.

In order to further explain the technical solution of the present invention, the present invention will be described in detail by way of specific examples.

### First Embodiment

As shown in FIG. 1 to FIG. 3, a first embodiment of the present invention comprises a plastic H-shaped main body A. The H-shaped main body A comprises a middle transverse pipe 1 and two valve seats 2 connected to left and right ends of the transverse pipe 1. The middle of the transverse pipe 1 is formed with a water outlet 11 extending upward. A flow passage is provided inside the transverse pipe 1 and the two valve seats 2 for the transverse pipe 1 and the two valve seats 2 to communicate with each other. The bottom of each valve seat 2 is provided with an inlet pipe 21 extending downward.

The front side of the transverse pipe 1 is provided with two openings 12. The two openings 12 are located at the left half and the right half of the transverse pipe 1, respectively. The two openings 12 are offset toward the left and right ends of the transverse pipe 1, respectively. A baffle 14 is provided between the two openings 12 at an intermediate portion of the transverse pipe 1. The baffle 14 is provided with a reinforcing plate 15 inside the transverse pipe 1. The reinforcing plate 15 is formed by a gap between three molds pulled from the two openings 12 and the water outlet 11, respectively.

Each opening 12 is fitted with a sealing plate 13 for sealing the opening 12. The periphery of the opening 12 is formed with an inwardly recessed annular groove 121. The sealing plate 13 is formed with a boss 131 to mate with the annular groove 121. The outer dimension of the boss 131 is the same as the inner dimension of the annular groove 121. The sealing plate 13 may be welded to the opening 12 by laser welding or hot melt welding.

### Second Embodiment

As shown in FIG. 4 to FIG. 6, a second embodiment of the present invention is disclosed, which differs from the first embodiment in that the second embodiment further comprises a housing 3. The housing 3 is formed by two-shot injection molding to the H-shaped main body A mated with the sealing plate 13. The housing 3 has a perforation 31 for the water outlet 11 to extend out therefrom. The housing 3 is configured to cover the H-shaped main body A and the sealing plate 13 so as to seal the seam between the sealing plate 13 and the opening 12, making the overall appearance neat and beautiful.

### Third Embodiment

As shown in FIG. 7, a third embodiment of the present invention is disclosed, which differs from the first embodiment in that the boss 131 of the sealing plate 13 is fitted with a sealing ring 4. The sealing plate 13 mated with the sealing ring 4 is fitted to the opening 12, so that the sealing ring 4 is sandwiched between the sealing plate 13 and the opening 12 to ensure the airtightness between the sealing plate 13 and the opening 12. The third embodiment also includes a housing 3. The housing 3 is formed by two-shot injection molding to the H-shaped main body A mated with the sealing plate 13. The housing 3 has a perforation 31 for the water outlet 11 to extend out therefrom. The housing 3 is configured to cover the H-shaped main body A and the sealing plate 13 so as to seal the seam between the sealing plate 13 and the opening 12, making the overall appearance neat and beautiful. The housing 3 also restricts the sealing plate 13, preventing disengagement of the sealing plate 13 and the opening 12 and preventing water leakage.

### The Fourth Embodiment

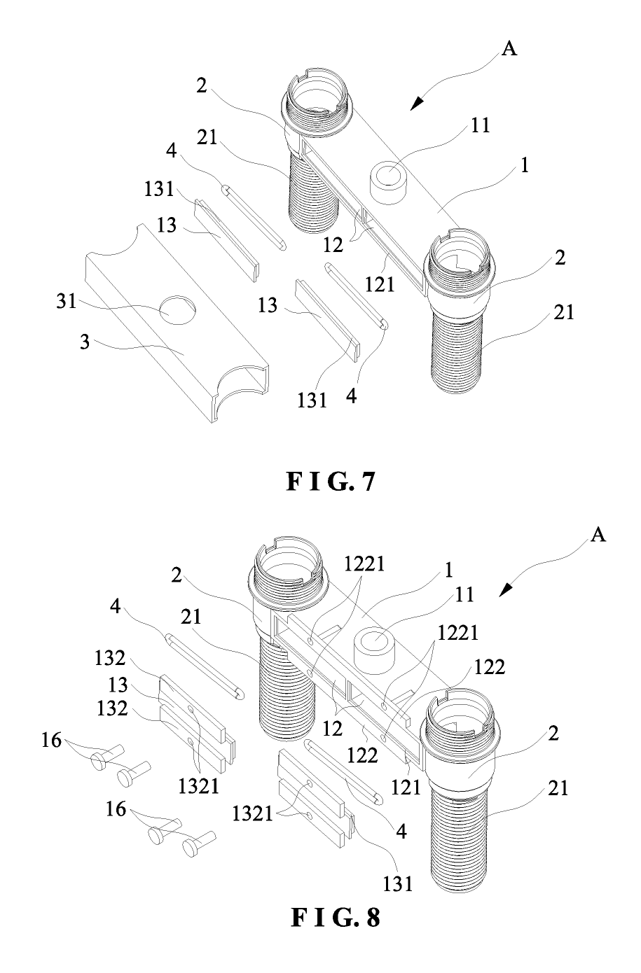

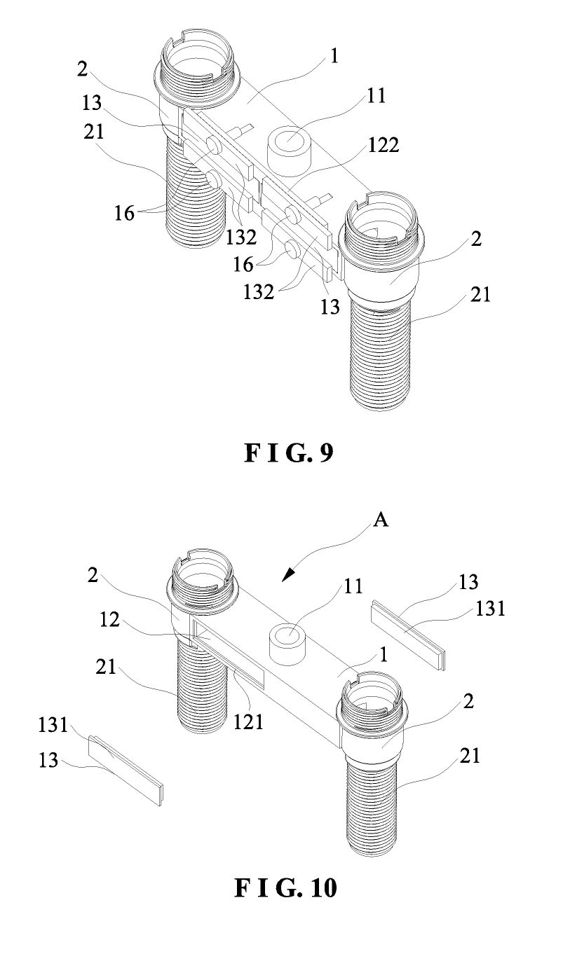

As shown in FIG. 8 and FIG. 9, a fourth embodiment of the present invention is disclosed, which differs from the first embodiment in that the boss 131 of the sealing plate 13 is fitted with a sealing ring 4 and the sealing plate 13 mated with the sealing ring 4 is fitted to the opening 12 by mechanical connection. Specifically, the opening 12 is provided with locking plates 122 extending from the upper and lower ends of the opening 12 respectively. The locking plates 122 are provided with locking holes 1221. The sealing plate 13 is provided with connecting plates 132 extending from the upper and lower ends of the sealing plate 13 respectively. The connecting plates 132 are provided with through holes 1321 corresponding to the locking holes 1221. The sealing plate 13 is fitted to the opening 12 by means of screws 16 inserting through the through holes 1321 and the locking holes 1221, and the sealing ring 4 is sandwiched between the sealing plate 13 and the opening 12 to ensure the airtightness of the sealing plate 13 and the opening 12.

### The Fifth Embodiment

As shown in FIG. 10 to FIG. 12, a fifth embodiment of the present invention comprises a plastic H-shaped main body A. The H-shaped main body A comprises a middle transverse pipe 1 and two valve seats 2 connected to left and right ends of the transverse pipe 1. The middle of the transverse pipe 1 is formed with a water outlet 11 extending upward. A flow passage is provided inside the transverse pipe 1 and the two valve seats 2 for the transverse pipe 1 and the two valve seats 2 to communicate with each other. The bottom of each valve seat 2 is provided with an inlet pipe 21 extending downward.

The front side of the transverse pipe 1 is provided with an opening 12 located at the right half of the transverse pipe 1. The rear side of the transverse pipe 1 is provided with another opening 12 located at the left half of the transverse pipe 1. The opening 12 located at the left half of the transverse pipe 1 is offset leftward from the central axis of the transverse pipe 1, and the opening 12 located at the right half of the transverse pipe 1 is offset rightward from the central axis of the transverse pipe 1. The right edge of the opening 12 located at the left half of the transverse pipe 1 and the left edge of the opening 12 located at the right half of the transverse pipe 1 are provided with reinforcing plates 15 inside the transverse pipe 1. The reinforcing plates 15 can enhance the strength of the present invention. The reinforcing plates 15 are formed by a gap between three molds pulled from the two openings 12 and the water outlet 11, respectively.

Each opening 12 is fitted with a sealing plate 13 for sealing the opening 12. The periphery of the opening 12 is formed with an inwardly recessed annular groove 121. The sealing plate 13 is formed with a boss 131 to mate with the annular groove 121. The outer dimension of the boss 131 is the same as the inner dimension of the annular groove 121. The sealing plate 13 may be welded to the opening 12 by laser welding or hot melt welding.

### Sixth Embodiment

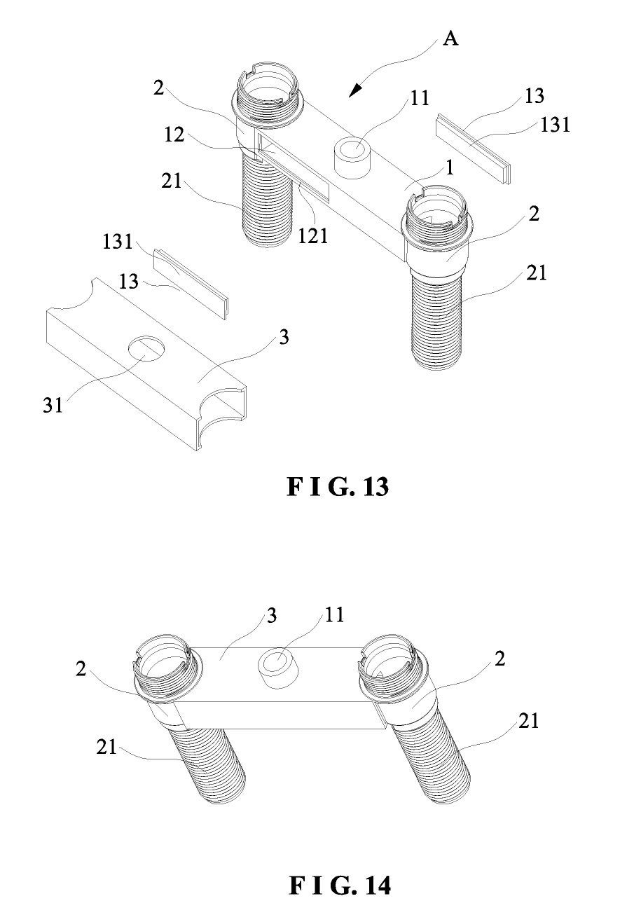

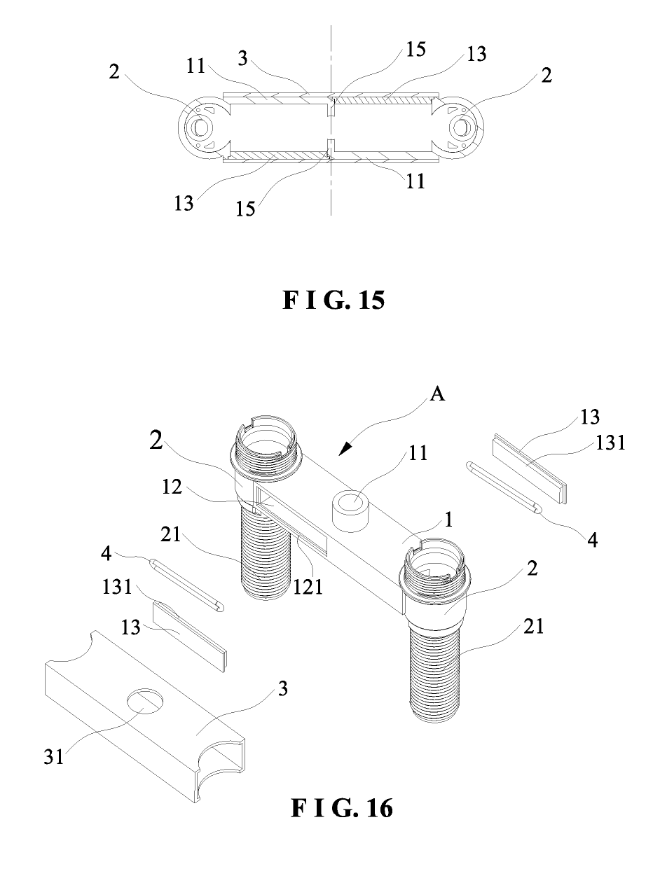

As shown in FIG. 13 to FIG. 15, a sixth embodiment of the present invention is disclosed, which differs from the fifth embodiment in that the sixth embodiment further comprises a housing 3. The housing 3 is formed by two-shot injection molding to the H-shaped main body A mated with the sealing plate 13. The housing 3 has a perforation 31 for the water outlet 11 to extend out therefrom. The housing 3 is configured to cover the H-shaped main body A and the sealing plate 13 so as to seal the seam between the sealing plate 13 and the opening 12, making the overall appearance neat and beautiful.

### Seventh Embodiment

As shown in FIG. 16, a seventh embodiment of the present invention is disclosed, which differs from the fifth embodiment in that the boss 131 of the sealing plate 13 is fitted with a sealing ring 4. The sealing plate 13 mated with the sealing ring 4 is fitted to the opening 12, so that the sealing ring 4 is sandwiched between the sealing plate 13 and the opening 12 to ensure the airtightness between the sealing plate 13 and the opening 12. The seventh embodiment also includes a housing 3. The housing 3 is formed by two-shot injection molding to the H-shaped main body A mated with the sealing plate 13. The housing 3 has a perforation 31 for the water outlet 11 to extend out therefrom. The housing 3 is configured to cover the H-shaped main body A and the sealing plate 13 so as to seal the seam between the sealing plate 13 and the opening 12, making the overall appearance neat and beautiful. The housing 3 also restricts the sealing plate 13, preventing disengagement of the sealing plate 13 and the opening 12 and preventing water leakage.

### The Eighth Embodiment

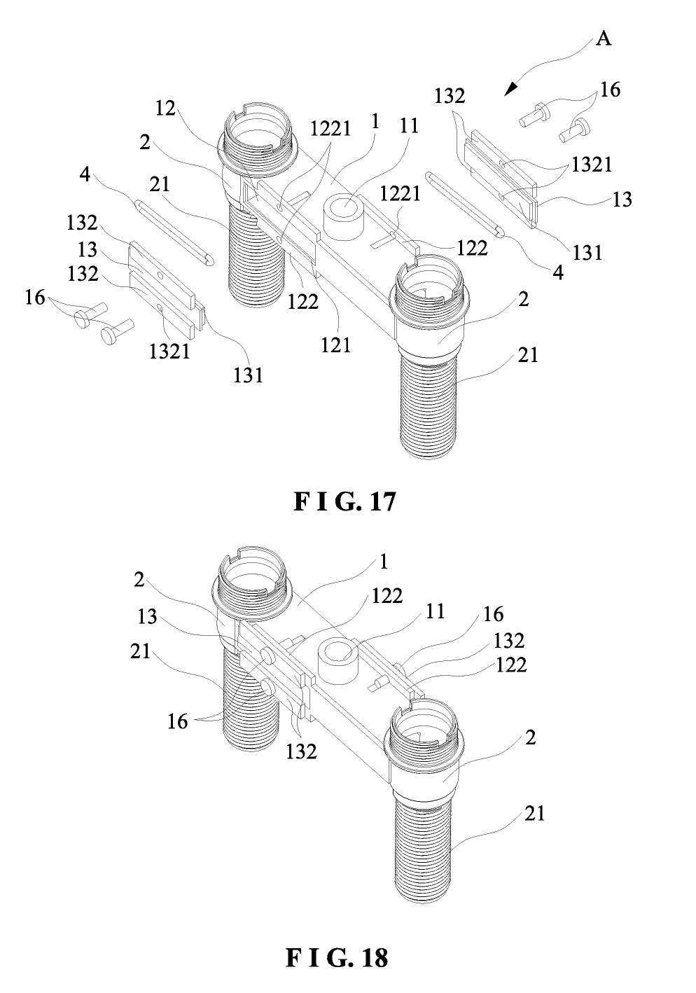

As shown in FIG. 17 and FIG. 18, an eighth embodiment of the present invention is disclosed, which differs from the fifth embodiment in that the boss 131 of the sealing plate 13 is fitted with a sealing ring 4 and the sealing plate 13 mated with the sealing ring 4 is fitted to the opening 12 by mechanical connection. Specifically, the opening 12 is provided with locking plates 122 extending from the upper and lower ends of the opening 12 respectively. The locking plates 122 are provided with locking holes 1221. The sealing plate 13 is provided with connecting plates 132 extending from the upper and lower ends of the sealing plate 13 respectively. The connecting plates 132 are provided with through holes 1321 corresponding to the locking holes 1221. The sealing plate 13 is fitted to the opening 12 by means of screws 16 inserting through the through holes 1321 and the locking holes 1221, and the sealing ring 4 is sandwiched between the sealing plate 13 and the opening 12 to ensure the airtightness of the sealing plate 13 and the opening 12.

Although particular embodiments of the present invention have been described in detail for purposes of illustration, various modifications and enhancements may be made without departing from the spirit and scope of the present invention. Accordingly, the present invention is not to be limited except as by the appended claims.

1. A plastic water passage main body of a thermostatic tap, comprising a plastic H-shaped main body; the H-shaped main body comprising a middle transverse pipe and two valve seats connected to left and right ends of the transverse pipe, a middle of the transverse pipe being formed with a water outlet extending upward, a flow passage being provided inside the transverse pipe and the two valve seats for the transverse pipe to communicate with the two valve seats, a bottom of each valve seat being provided with an inlet pipe extending downward; wherein one side or two sides of the transverse pipe being provided with two openings communicating with the flow passage inside the transverse pipe, each opening being fitted with a sealing plate for sealing the opening;
wherein the two openings are located at the two sides of the transverse pipe, respectively; and
wherein a reinforcing plate is provided between the two openings at an intermediate portion of the transverse pipe and extends in a direction from a location between the two openings into the flow passage.

2. (canceled)

3. The plastic water passage main body of the thermostatic tap as claimed in claim 2, wherein a baffle is provided between the two openings at an intermediate portion of the transverse pipe, and the baffle is provided with a reinforcing plate inside the transverse pipe.

4. The plastic water passage main body of the thermostatic tap as claimed in claim 1, wherein the two openings are located at same side of the transverse pipe.

5. The plastic water passage main body of the thermostatic tap as claimed in claim 4, wherein one side edge of each opening, close to a central axis of the transverse pipe, is provided with a reinforcing plate inside the transverse pipe.

6. The plastic water passage main body of the thermostatic tap as claimed in claim 1, wherein a periphery of each opening is formed with an inwardly recessed annular groove, and the sealing plate is formed with a boss to mate with the annular groove.

7. The plastic water passage main body of the thermostatic tap as claimed in claim 6, wherein a sealing ring is provided between the sealing plate and each opening.

8. The plastic water passage main body of the thermostatic tap as claimed in claim 1, wherein a sealing ring is provided between the sealing plate and each opening.

9. The plastic water passage main body of the thermostatic tap as claimed in claim 1, wherein the sealing plate is connected to each opening by a welding connection or mechanical connection.

10. The plastic water passage main body of the thermostatic tap as claimed in claim 1, further comprising a plastic housing, the housing being configured to cover the H-shaped main body and the sealing plate, the housing having a perforation for the water outlet to extend out therefrom.
